(19) United States
(12) Patent Application Publication
(10) Pub. No.: US 2015/0022443 A1
(43) Pub. Date: Jan. 22, 2015

(54) Process and Apparatus for Haptic Interaction with Visually Presented Data

(71) Applicant: Technische Universität Dresden, Dresden (DE)

(72) Inventors: Andreas Richter, Dresden (DE); Boris Velichkovsky, Dresden (DE); Sebastian Pannasch, Dresden (DE); Jens Helmert, Dresden (DE); Georgi Paschew, Dresden (DE)

(21) Appl. No.: 14/331,239

(22) Filed: Jul. 15, 2014

(30) Foreign Application Priority Data
Jul. 18, 2013 (DE) 102013214148.3

(51) Int. Cl. G06F 3/01

(52) U.S. Cl. CPC G06F 3/016
USPC 345/156

(57) ABSTRACT

The invention relates to a system and a method for haptic interaction with visually presented objects. In the process, three-dimensional data of the user and an object are captured and presented in a visual subsystem. At the same time, there is an interaction of the user with a haptic element in a haptic subsystem, wherein the haptic element is designed in such a way that it can imitate the surface characteristics of the object in the collision area of the hand and object.

### CROSS REFERENCE TO RELATED APPLICATIONS

This application claims the benefit under 35 USC 119 of German Application No. 102013214148.3 filed on Jul. 18, 2013; all applications are incorporated by reference herein in their entirety.

### BACKGROUND

The invention relates to a method and apparatus for haptic interaction with visually presented data.

### PRIOR ART

A significant technological upheaval is taking place at present in the area of communication and information technology. Smartphones and tablet computers have tremendous performance capabilities with a design that is more and more compact. Both are made possible, and not in an insignificant way, by the displays that are used. They are multi-functional components that act both as visual output devices and as touch-sensitive input devices. Moreover, they frequently provide visual-auditory or tactile, vibration-based feedback in response to input events.

A substantial shortcoming of the rapidly growing information and interaction technologies is the limitation of communication between people and machines in auditory and visual channels. Complex audio-visual 3D impressions can, in fact, be conveyed in the meanwhile, but a realistic presentation of tactile objects has not been possible up to now.

Active feeling of size, contours, surface texture, weight etc. of an object via the integration of all of the skin senses and depth sensitivity is designated as haptic perception. The entirety of haptic perceptions permits the brain to locate and evaluate mechanical stimuli, temperature stimuli and pain. The senses of haptic perception in people are: tactile perception (part of surface sensitivity), kinesthetic perception/proprioception (depth sensitivity), temperature perception (thermoception) and pain perception (nociception).

Technologies for the simulation of reality, for instance virtual reality (VR) and augmented reality (AR), offer undreamt-of possibilities for expanding human perception. All of the senses should be stimulated for realistic perception of the VR/AR worlds. Current systems make the stimulation of seeing, hearing and feeling possible to varying degrees. Three-dimensional and high-quality visual presentations are necessary to get visual realism; the realism can be significantly increased via an additional presentation of three-dimensional acoustic information.

The sense of touch is essential for a physical interaction with the virtual world, however. It plays a significant role for people both in the near-field detection of objects within their reach and in the manipulation of objects. Systems that perfectly convey all of the required impressions do not yet exist today. Whereas the integration of three-dimensional acoustic impressions into a given virtual environment can be technically realized relatively little effort, visual and especially tactile information and their coordination with human perceptual habits involve substantial challenges.

There are significant activities in the area of three-dimensional visual presentations. The technical challenge is above all the fulfillment of the demands of a high level of realism with simultaneous real-time performance capabilities. Current developments in this field are primarily concerned with possibilities for the efficient processing of large amounts of data, principles for presenting virtual information and real-time performance capabilities for its visual presentation.

The development status of systems that serve the sense of touch is significantly more differentiated. Two types can basically be distinguished here.

Kinesthetic displays convey realistic impressions to the user for the manipulation of virtual objects by imparting dynamic mechanical effects on the person with their effectors. They thereby simulate the kinesthetic sensors of people that convey impressions via the inner state of a body part through joint angles and muscle tension. Moreover, it is possible to bring dynamic events to life via vibrations of the kinesthetic display. There are three embodiments of kinesthetic displays: active joysticks, force feedback displays (FFD, usually manual) and displacement feedback displays (DFD), which include larger body parts, e.g. the arm, in the display system. Several commercialized products that can also be coupled to visual 3D systems already exist in this area. Kinesthetic displays are control loops, i.e. a person should also be able to influence the virtual world through these systems. Kinesthetic displays are characterized by the fact that the user always interacts with the virtual object through an auxiliary element, however. This can be an active joystick that acts as a manually operated tool, an active glove that the user's hand is in with regard to the force feedback display or an active, overall effector system that the entire arm of the user is in with regard to the displacement feedback system.

Handels (Handels, H.: Medizinische Bildverarbeitung [Medical Image Processing]. 2nd ed. Vieweg+Teubner, 2009, pp. 334-344, ISBN 978-3-8351-0077-0) discloses various haptic elements that are designed to be haptic input and output devices. They provide the user with force feedback, so a haptic impression of the virtual object arises for the user. Styluses and joysticks are mentioned here, among other things, as tool-based, haptic force-feedback devices.

Furthermore Stone (Stone, R. J., Haptic feedback: A brief history from telepresence to virtual reality. In: Haptic Human-Computer Interaction. pp. 1-16, Springer Berlin Heidelberg, 2001) describes haptic feedback systems such as glove, stylus or joystick-based systems.

U.S. Pat. No. 6,704,694 B1 also discloses a stylus-based haptic interface system.

In addition, cutaneous or tactile displays are known. They permit a person to explore the virtual world with his sense of touch by feeling the surfaces of virtual objects with his bare hands. Until recently, developments were nowhere near the ability to convey realistic impressions with regard to the surface characteristics of a virtual object. There are three types of tactile displays in principle. Electro-tactile displays stimulate the skin electrically; a method that only a few people can get used to in and of itself. Vibro-tactile displays convey impressions on the texture and in part on the flexibility of surfaces to people via the frequency and amplitude of the vibration of a surface. Contours and profiles can only be presented with a low level of precision, though, because the vibro-tactile principle has a lack of spatial resolution. This principle is suitable for 60-80% of users. Static or displacement displays are ideal based on the high level of realism for all users, because these systems replicate surfaces in a physically real way. Up to now, though, there were no physical and technical possibilities to realize static tactile displays with sufficiently high spatial resolution and with the required multimodality to present textures, contours, reliefs and the softness of a surface, for instance.

WO 2009/061572 A1 discloses a thermal haptic element that is designed to change the thermal characteristics of individual cells of the haptic element. A thermal impression of a virtual object can be conveyed to the user because of that. The haptic element is not suitable for a targeted manipulation of the virtual object, however.

US 2003/0227374 A1 also describes a modular, electro-tactile system in which tactile stimuli of the skin of the user are provided.

DE 10 2006 036 867 A1 discloses a rewritable device for displaying tactile and/or visual information, wherein at least one functional layer made of a functional material (1, 1a-1f) is locally changed with regard to its optical, aggregation-state, cross-linkage and/or swelling characteristics via the influence of at least one physical quantity that can be controlled in terms of its local effect; the functional layer can retain this state until a physical quantity provides an influence once again. The functional layer can be made up of hydrogel elements, for instance. The monolithic integration of the hydrogel functional layer allows high-resolution tactile displays to be realized. In Adv. Mater. 21 (2009), pp. 979-983, a display of that type is described with a total of 60×72 (4320) actuator pixels, the so-called texels, with an integration density of 297 elements per cm².

The above-mentioned systems are designed in such a way, however, that either a direct, haptic interaction with the virtual object without the use of tool-based, haptic force-feedback systems or real overall perception of the virtual object as a percept is not possible for the user.

A perception experience, and thus the subjectively experienced, real-life, conscious (phenomenal) result of a perception process, is called a percept in psychology. In the process, visual and kinesthetic impressions are combined by the brain into an overall experience that is interpreted as real by the brain.

### SUMMARY

The invention relates to a system and a method for haptic interaction with visually presented objects. In the process, three-dimensional data of the user and an object are captured and presented in a visual subsystem. At the same time, there is an interaction of the user with a haptic element in a haptic subsystem, wherein the haptic element is designed in such a way that it can imitate the surface characteristics of the object in the collision area of the hand and object.

### DETAILED DESCRIPTION

The object of the invention is to therefore provide a system that overcomes the drawbacks in the prior art and makes a system available via which the percept is conveyed to a user, a virtual object that he visually perceives in a three-dimensional fashion and that is also able to be explored via direct haptic interaction with at least one body part of the user without having to use tool-based haptic elements for this.

The problem is solved by a system in accordance with claim 1. Advantageous design forms are specified in the dependent claims.

As per the invention, a system for haptic interaction with visually presented data is provided comprising:
at least one device for capturing three-dimensional data of an object,
at least one second device for capturing three-dimensional data of a user,
at least one data-processing device for processing the captured three-dimensional data of the object and of the user and for generating a visual representation of the three-dimensional data,
at least one visual subsystem with a display device for visual presentation of the three-dimensional data,
at least a tactile subsystem with a haptic element for interaction with the user, wherein the haptic element is designed to be at least one tactile display, a vibro-tactile display alone or also in combination with a static display and
wherein the visual subsystem is arranged above the tactile subsystem, wherein the distance between the visual and the tactile subsystems is 50 cm>x>15 cm, preferably 40 cm>x>20 cm, as a special preference 35 cm>x>25 cm.

As per the invention, the three-dimensional data of an object, for instance of a patient, is captured by means of a first device for capturing three-dimensional data. The first device can be an imaging device (MRT, ultrasound etc.), as an example. Furthermore, the three-dimensional data of a user is captured by means of a second device for capturing three-dimensional data of the user; the second device is designed to be an optical sensor, for instance. In accordance with the invention, the object and the user are spatially separated in such a way that direct interaction of the user with the object does not take place or cannot take place. The three-dimensional data of the object and of the user that is captured in this way is processed in a data-processing unit, and a visual representation of the three-dimensional data of the object and the user that has been processed is generated. This three-dimensional data of the object and of the user that has been processed is presented in a visual subsystem with a display device for visually presenting the three-dimensional data. It is advantageous with regard to the presentation of the three-dimensional data of the user if at least the body part interacting with the object, for instance the hand, is presented in the visual system. In so doing, the visually presented data of the user and of the object are presented in a visual subsystem, so the real, spatially separated user and object in the visual system are presented in a virtual fashion in spatial proximity. The user herself does not directly interact with the object presented in the visual system, however, but instead with a haptic element in a tactile subsystem.

The interaction of at least one part of the visually presented user with the visually presented object in the visual subsystem is presented simultaneously with the interaction of the user with a haptic element in the tactile subsystem, wherein a collision point is ascertained when there is a collision between the at least one part of the visually presented user with the visually presented object. The three-dimensional data of the object that is captured at the collision point of the at least one part of the visually presented user with the visually presented object is reproduced in the tactile subsystem, wherein the haptic element has a surface with a structure that is designed to reproduce the three-dimensional structure of the object at the collision point based on the three-dimensional data of the object that is captured, at least in the area of the collision point.

The haptic element, as per the invention, is designed to be at least a tactile display or a vibro-tactile display or also as a combination of a tactile or vibro-tactile display with a static display.

It is important for the invention, however, that the visual subsystem is separately arranged above the tactile subsystem, wherein the distance between the visual and the tactile subsystems is 50 cm>x>15 cm, preferably 40 cm>x>20 cm, as a special preference 35 cm>x>25 cm. The formation of a percept is only possible via a suitable spatial separation of the visual subsystem above the tactile subsystem, because the haptic information recorded in the tactile subsystem can only be combined within these limits with the virtual information presented in the visual subsystem for form an overall percept that can subsequently be interpreted as real by the brain of the user. A deviation from these separation limits leads to the result that the overall impression is perceived as inconsistent and consequently not real. The haptic information regarding the object presented in the visual subsystem that is subsequently reproduced by the tactile subsystem is not accepted as being real by the user because of that, and it therefore loses a substantial amount of information content.

It is consequently possible to make objects tangible that are normally not accessible or only accessible with difficulty with the system or even device as per the invention. As an example, an anamnesis of internal organs can consequently be taken without a local opening of the patient being necessary for this. Moreover, remote diagnoses can be done by specialists for patients who cannot be transported. Likewise, global treatment of complicated cases can be done by demonstrated specialists because of that.

Using this system for evaluating materials or individual components is also conceivable, though. Further applications are conceivable in sports, and in the leisure and entertainment areas, where haptic interaction with a visually presented object appears to be desirable.

It is well known that people are cognitively most efficient in the intermodal (simultaneously visual and tactile) perception area. People's perception possibilities and limits are being investigated with the means of applied cognition research, but also for the separate information channels. The tactile information channel, which involves the human ability to feel reliefs, edges, textures and differences in softness with structures that are within the framework of the presentation possibilities of the tactile display in principle, has special importance.

In a first embodiment of the invention, the first and/or second device for capturing the three-dimensional data is designed to be a non-invasive imaging device. The quality of the information presented by the intermodal 3D percept system, which is also occasionally called a 4D display, is determined not just by its performance in the clinical area, for instance, but also by the performance of the imaging diagnostics that establish the raw data. A combination of several imaging processes is also conceivable here. As an example, hybrid processes that include the results of other diagnostic processes in the intermodal information space are interesting in the area of magnetic resonance tomography. Information regarding the activity of the brain areas of interest, which can be ascertained by means of functional magnetic resonance tomography (fMRT) or electroencephalography (EEG), can be integrated, as an example, while information can be obtained about their nerve-fiber connections from diffusion studies.

In a further embodiment of the invention, the first and/or second device for capturing the three-dimensional data is selected from the group consisting of optical sensors in the IR, VIS and UV range, CCD cameras, CMOS sensors, impedance measurement, sonography, magnetic resonance imaging, scintigraphy, positron emission tomography, single-photon emission computer tomography, thermography, computer tomography, digital volume tomography, endoscopics or optical tomography. The magnetic resonance tomography and sonography also ascertain material information in addition to spatial arrangements. The sonography supplies information on anatomical details in B mode, on vascular flows in the Doppler process and on mechanical tissue characteristics with acoustic radiation force impulse imaging (ARFI). The instant system advantageously permits a simultaneous provision of these information dimensions for the user. That takes place in a form in which the user can use her natural near-field recognition method, the combined seeing-feeling process, so that she can immediately and very accurately evaluate the information, just as if the object were actually in front of her. In so doing, differences such as certain material characteristics in the visual space are reproduced via pseudo-color presentations, textures and visual contrasts, for instance, and by the hardness, height, textures, reliefs, edges and tactile contrasts in the tactile area. The visual and haptic/tactile data channels that are coordinated with one another in terms of time generate the realistic impression for the user that the virtual object is actually in front of him and could be explored by feeling it with his hands.

In a further embodiment of the invention, the haptic element has an actuator pixel matrix made up of actuator pixels. The actuator pixels can be designed based on intrinsically active polymers, for instance. Intermodal displays can be created in this way that can physically reproduce surfaces in an extremely precise way, which has been technically impossible up to now, because of their high resolution of up to 625 individually controllable actuator pixels per square centimeter and their multi-modality. The modalities of the actuator pixels include, in addition to optical functionality, the tactile parameters of actuator pixel volume, height and softness, which can each be modulated by almost an order of magnitude. A display based on these actuator pixels can therefore convey impressions of a virtual surface with regard to contours, reliefs, textures and softness [Adv. Sci. Technol. 82 (2013), 44-49].

In a further embodiment of the invention, actuator pixels are made of polymers whose phase transition behavior can be influenced by environmental quantities. Physical parameters such as pressure, temperature or illumination intensity, or chemical parameters such as pH value or osmotic pressure, can serve as environmental quantities in the process. The phase transition behavior of the actuator pixels is influenced by these environmental quantities, at least in the area of the collision point of the user with the haptic element, so the actuator pixels can reproduce the structural characteristics of the object at the haptic element. In the process, information with regard to density, pressure, pliability and surface design of the object can also be made accessible to the user by means of the haptic element.

In a further embodiment of the invention, the actuator pixels are made of hydrogels that are designed to be capable of being influenced in terms of their phase transition behavior via the input of electrical, chemical or thermal energy. The phase transition behavior of the hydrogels is influenced in the process by the input of electrical, chemical or thermal energy to the effect that the phase behavior is changed and there is consequently a direct change in the mechanical characteristics of the hydrogel at the actuator pixel. Information regarding the characteristics of the object, at least at the collision point, can be reproduced in a targeted way by the haptic element because of that.

In a further embodiment of the invention, the system further includes a third device for capturing three-dimensional data of the user; the third device is designed to capture the eye movement of the user. The eye movements are tracked by the third device to determine the direction in which the user is looking. That is advantageous when the visual subsystem is also supposed to provide a reproduction of the nearby environment. The percept is strengthened by this to the effect that the difference between the virtual presentation and the real environment is eliminated to a great extent, so the percept can more be more strongly interpreted as real. Furthermore, the high-resolution virtual presentation in the visual subsystem can be limited to the area that is perceived as being the field of vision of the user by the tracking of the eye movements and the determination of the direction in which the user is looking. Adjacent areas that are only perceived partially or peripherally in the process can be presented with less detail here; the computation efforts for calculating the presentation can be reduced because of that. The use of a system contingent upon eye contact based on an eye tracker also offers the user the possibility of actuating certain supplemental functions with the eyes such as zooming, object rotation and the like.

In a further embodiment of the invention, the third device is a stationary system selected from a pan-tilt system, a tilting-mirror system or a fixed-camera system.

A part of the invention is also a process for haptic interaction with visually presented data, comprising the following steps:
Capturing three-dimensional data of an object in real time,
Capturing three-dimensional data of a user in real time,
Generation of a visual real-time presentation of the three-dimensional data of the object,
Generation of a visual real-time presentation of at least one body part of the user based on the three-dimensional data of the user,
Presentation of the three-dimensional data of the object and of the at least one body part of the user in a visual subsystem, wherein the visually presented three-dimensional data of the object is represented with the visually presented three-dimensional data of the user in a display device of the visual subsystem, wherein the interaction of the at least one part of the visually presented user is represented with the visually presented object in the visual subsystem and the simultaneous interaction of the user with a haptic element in a tactile subsystem, wherein a collision point is determined when there is a collision of the at least one part of the visually presented user with the visually presented object, wherein the presentation in the visual subsystem takes place at a distance of 50 cm>x>15 cm, preferably 40 cm>x>20 cm, as a special preference 35 cm>x>25 cm above the haptic subsystem and
The three-dimensional data of the object that is captured at the collision point of the at least one part of the visually presented user with the visually presented object is reproduced in the tactile subsystem, wherein the haptic element has a surface with a structure that is designed to reproduce the three-dimensional structure of the object at the collision point based on the three-dimensional data of the object that is captured, at least in the area of the collision point.

It is important in the process for the software framework to be merged with a synchronism and level of coordination meeting the very high quality requirements of the system. Various sub-tasks concern themselves here with the merging of the visual presentations (rendering) of the object and the user hands in the virtual subsystem and the integration of the collision-point determination.

It is important for the invention that the presentation in the visual subsystem is at a distance of 50 cm 22 x>15 cm, preferably 40 cm>x>20 cm, as a special preference 35 cm>x>25 cm above the haptic subsystem. The visual information of the visual subsystem and the haptic information of the tactile subsystem are only combined to form an overall percept, and the perception formed in this way is interpreted as being real by the brain of the user, in this area.

The following takes place in a further embodiment of the invention:
The hand movement of the user is captured in real time when the three-dimensional data of the user is captured,
A visual real-time presentation of the hand movement of the user is generated based on the captured hand movement of the user,
The visual real-time presentation of the hand movement is represented in the visual subsystem, wherein the interaction of the visually presented real-time representation of the hand movement of the user is represented with the visually presented object in the visual subsystem, so the real-time representation of the hand movement of the user interacts with the visually presented object, wherein the collision point is calculated when there is a collision of the visually presented real-time representation of the hand movement of the user with the visually presented object in the visual subsystem and
at least the three-dimensional data of the object captured at the collision point is reproduced in the tactile subsystem.

The real-time implementation of the user hand into the visual 3D system requires the realization of an efficient hand-tracking system that captures the hand pose and position and that simulates and renders the hands in real time. Furthermore, the determination of the collision point is of considerable importance. It is important, on the one hand, for the creation of the intermodal percept in a person; on the other hand, the collision point also determines the center point of the surface that is to be presented by the tactile display unit, as well as the angle of tilt or the position that the tactile display has to assume in the visual presentation in accordance with the surface to be touched.

In a further embodiment of the invention, the process also includes the
Capture of the eye movements of the user
Processing of the captured eye-movement data and determination of an active field of view of the user
Implementation of the captured eye-movement data and of the active field of view in the visual subsystem, wherein the captured eye-movement data of the user provides a local adjustment of the visual presentation of the objects and of the visual presentation of the hand movements in the area of the active field of view.

The use of a system contingent upon eye contact based on an eye tracker offers the user the possibility of actuating certain supplemental functions with the eyes such as zooming, object rotation and the like.

It is possible for the first time with the instant invention to present the information to the user, for instance a physician, in the intermodal (visual-tactile) information space. This means that he has the feeling that the organ that is actually in the patent, of course, is directly in front of him as an object, because he can examine it in a real, three-dimensional way and feel it with his bare hands.

The modern, non-invasive imaging diagnostics (magnetic resonance tomography, computer tomography, sonography) provide the data required for this. If their performance capabilities are fully exploited, they also provide quantitative information on the medical characteristics of the tissue in addition to information on anatomies and vascular flows. The physician can examine and feel the data that is obtained as pathological structures in relation to their neighboring organs as if the patent had already been opened up. The information processing is also in a position to specially emphasize aspects relevant to an evaluation, for instance via contrast enhancement and by presenting interesting details with much more than natural precision via enlargement (zooming). The methodologies of diagnosis, operation planning and execution are simplified in fundamental ways by these possibilities.

An entire series of new functions and methods result in the area of screening and diagnostics. The system as per the invention offers, for instance, enormous strengths for the evaluation of the relationship of the pathological structure to its neighboring organs. This would crucially simplify and provide significantly more reliable organization for the evaluation of the benign nature of tumors such as tumors of the breast, for instance.

The system as per the invention can be used in the following areas: in clinical imaging diagnostics, in the construction of vehicles and mechanical engineering, in material testing and in the areas of leisure, sports, entertainment and shopping.

The above-mentioned embodiments in accordance with the invention are suitable for solving the problem. In so doing, combinations of the disclosed embodiments are also suitable for solving the problem. Preferred further design developments of the invention follow from the combinations of claims or individual features thereof.

### BRIEF DESCRIPTION OF THE DRAWINGS

The invention is to be explained in more detail below with the aid of a few examples and the accompanying figures. The examples are intended to describe the invention without limiting it to them.

The following are shown in the figures:

FIG. 1a and 1b show a schematic representation of a system as per the invention and

FIG. 2 shows a schematic diagram of the course of the process as per the invention.

### DETAILED DESCRIPTION OF THE PREFERRED EMBODIMENT

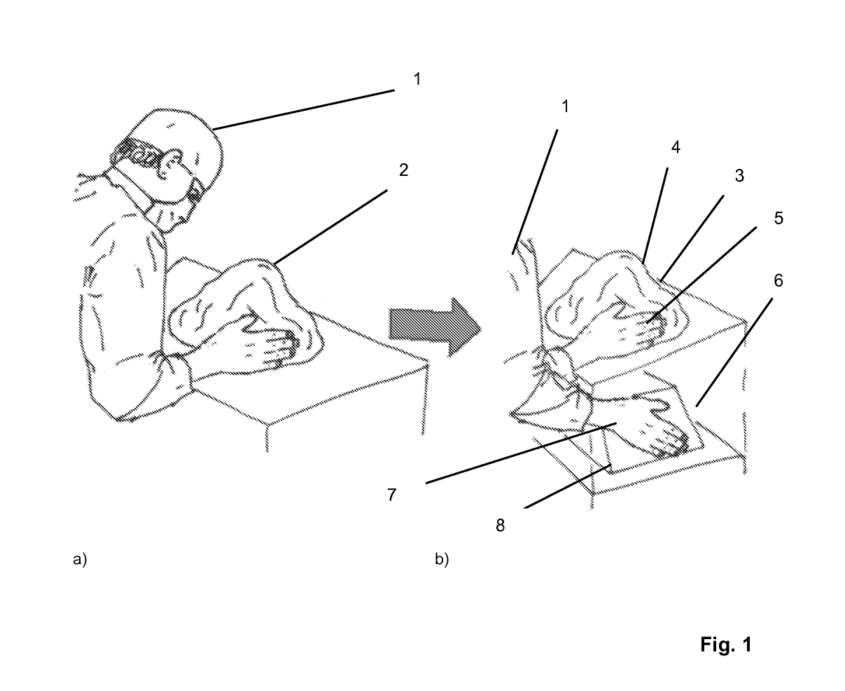

The functional principle of the system as per the invention (intermodal 3D percept system) is illustrated in FIG. 1 in a first example. FIG. 1a shows the interaction of a user 1 with a virtual, 3D perceptive object 2. The object 2 presented here is created by the visual subsystem 3 represented in FIG. 1b. The object of interest is presented as a three-dimensional, visually presented object 4 in the visual subsystem 3. The hand of the user 1 is also reproduced in the visual subsystem 3 as a visual reproduction 5. The tactile subsystem 6, which conveys impressions with regard to the surface of the object image in the hand-contact or collision area, is located in a plane that is only slightly offset. The visual subsystem 3 is arranged above the tactile subsystem 6 here, wherein the distance between the visual and the tactile subsystems 3, 6 is 50 cm>x>15 cm, preferably 40 cm>x>20 cm, as a special preference 35 cm>x>25 cm. In the tactile subsystem 6, the real hand of the user 7 acts with a haptic element 8, which is designed in such a way that it can imitate the tactile characteristics of the object 2 in the collision area. A tactile or vibro-tactile display can be used here, as an example, as the haptic element 8. Alternatively, an actuator-pixel-based display can be used. Since the user does not see his real hands 7, but instead their real-time reproductions 5 that are presented in the visual subsystem 3, his cognitive perception combines the visual and tactile impressions to form a uniform percept, so he experiences the object 2 as being capable of being seen and touched in a real way.

The system is comprised of two subsystems. A) Visual subsystem 3: visually presents the object 2, e.g. an organ, that is captured with imaging processes, for instance, in a three-dimensional way. The visually presented hands 5 of the user are projected in real time into this visual representation of the object 4, so he perceives this in a direct spatial relationship with the object 2. B) Tactile subsystem 6: In the moment of the collision of the visually presented hand 5 and the visually presented object 4 in the visual image, the user 1 touches the surface of the haptic element 8 with his real hand 7 in the tactile subsystem 5, which is not visible to him, situated only a few centimeters below the visual subsystem 3. This displays the surface conditions of the object 2 at the collision point, which are likewise determined by the imaging processes. The haptic element 8 is aligned in accordance with the surface orientation at the collision point. The user experiences the visually presented object 4 as if it were concretely in front of him as a real object 2. The haptic element 8 can have a surface made of individually controllable actuator pixels, for instance, which permit modulation of the solidity and volume; they can reproduce the characteristics of the object 2 at the collision point because of that.

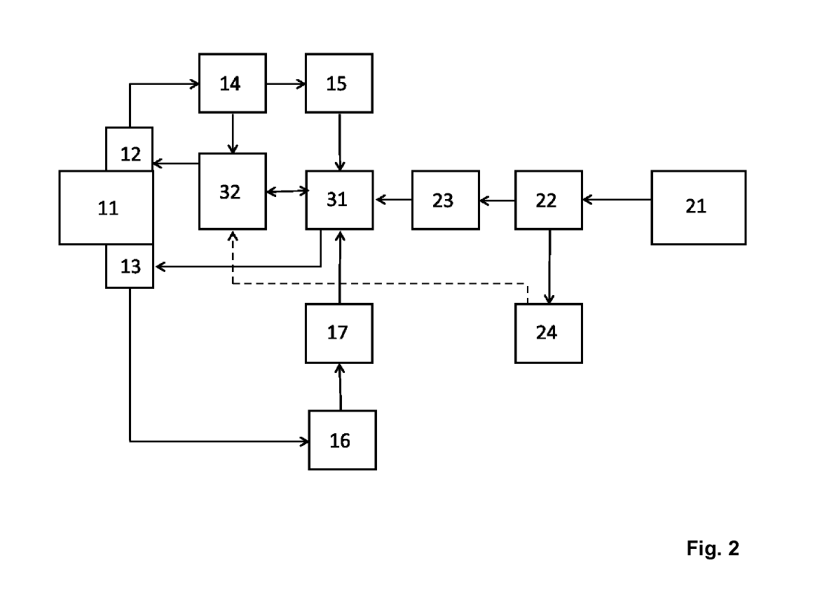

In a further example, the course of the process for haptic interaction with the visually presented object is shown in FIG. 2.

The movement of the hands 12 and eyes 13 of the user 11 is captured here via appropriate processes. The hand movement can be captured via optical processes with several cameras (hand tracking) as an example. The hand-movement data that is captured in this way is calculated in a data-processing device 14 that is not shown in more detail, and a visual presentation of the hand movement 15 is generated. At the same time, the eye movement is captured via suitable processes (eye tracking) 16 and a field-of-view calculation is done. The direction in which the user 11 is looking can consequently be computed based on the data obtained when the eye movement is captured 16.

Furthermore, the three-dimensional data and material characteristics of an object 21 are captured (22) via suitable, preferably imaging processes. A calculation for the visual presentation of the object 21 is done based on the data that is captured 22. The visually presented object 23 that is created is now combined in a visual subsystem 31 with the visually presentation of the hand movement 15.

The visually presented hand 15 simultaneously approaches the visually presented object 23 in the visual subsystem 31 in the subsequent interaction. At the same time, the real hand 12 of the user 11 approaches a haptic element in a tactile subsystem 32 that is capable of reproducing the material characteristics of the object 21 in the vicinity of the collision point of the hand with the object. The material characteristics of the object are calculated (24) from the data of the imaging processes and can then be conveyed to the haptic element in the tactile subsystem 32; a precise imitation of the surface characteristics of the object 21 is possible because of that. As a result, the user 11 sees with his eyes 12 the interaction of the visually presented object 23 with the visually presented hand 15 represented in the visual subsystem 31; at the same time, the user touches the haptic element in the tactile subsystem 32 with his real hands 13. The user 11 experiences perception of the visually presented object 23 via the superposition of the visual perception and the tactile information.

### LIST OF REFERENCE NUMERALS

1 User
2 Object
3 Visual subsystem
4 Visually presented object
5 Visually presented hand of the user
6 Tactile subsystem
7 Real hand of the user
8 Haptic element
11 User
12 Hands of the user
13 Eyes of the user
14 Capture of the hand movement
15 Visual presentation of the hand movement
16 Capture of the eye movement
17 Determination of the field of view
21 Object
22 Capture of the object
23 Visual presentation of the object
24 Calculation of the material characteristics
31 Coordinated visual presentation of the visual object and the visual hand
32 Tactile subsystem Claims

1. System for haptic interaction with visually presented data comprising:
at least one device for capturing three-dimensional data of an object,
at least one second device for capturing three-dimensional data of a user,
at least one data-processing device for processing the captured three-dimensional data of the object and of the user and for generating a visual representation of the three-dimensional data,
at least one visual subsystem with a display device for visual presentation of the three-dimensional data,
at least one tactile subsystem with a haptic element for interaction with the user, wherein the haptic element is designed to be at least one tactile display, a vibro-tactile display alone or also in combination with a static display and wherein the visual subsystem is arranged above the tactile subsystem and the distance between the visual subsystem and the tactile subsystem is 50 cm>x>15 cm, preferably 40 cm>x>20 cm, as a special preference 35 cm>x>25 cm.

2. System according to claim 1, characterized in that the first and/or second device for capturing the three-dimensional data is designed to be an imaging device.

3. System according to claim 1, characterized in that the first and/or second device for capturing the three-dimensional data is selected from the group consisting of optical sensors in the IR, VIS and UV range, CCD cameras, CMOS sensors, impedance measurement, sonography, magnetic resonance imaging, scintigraphy, positron emission tomography, single-photon emission computer tomography, thermography, computer tomography, digital volume tomography, endoscopics or optical tomography.

4. System according to claim 1, characterized in that the haptic element has an actuator-pixel matrix made up of actuator pixels.

5. System according to claim 4, characterized in that the actuator pixels are made of polymers whose phase transition behavior is capable of being influenced by environmental quantities.

6. System according to claim 5, characterized in that the actuator pixels are made of hydrogels that are designed to be capable of being influenced in terms of their phase transition behavior via the input of electrical, chemical or thermal energy.

7. System according to claim 1, further comprising a third device for capturing three-dimensional data of the user, wherein the third device is designed to capture eye movements of the user.

8. System according to claim 7, characterized in that the third device is a stationary system selected from the group consisting of a pan-tilt system, a tilting-mirror system or a fixed-camera system.

9. Method for haptic interaction with visually presented data comprising the steps:
capturing three-dimensional data of an object in real time,
capturing three-dimensional data of a user in real time,
generation of a visual real-time presentation of the three-dimensional data of the object,
generation of a visual real-time presentation of at least one body part of the user based on the three-dimensional data of the user,
presentation of the three-dimensional data of the object and of the at least one body part of the user in a visual subsystem, wherein the visually presented three-dimensional data of the object is represented with the visually presented three-dimensional data of the user in a display device of the visual subsystem, wherein the interaction of the at least one part of the visually presented user is represented with the visually presented object in the visual subsystem and the simultaneous interaction of the user with a haptic element in a tactile subsystem, wherein a collision point is determined when there is a collision of the at least one part of the visually presented user with the visually presented object, wherein the presentation in the visual subsystem takes place at a distance of 50 cm>x>15 cm, preferably 40 cm>x>20 cm, as a special preference 35 cm>x>25 cm above the tactile subsystem and
the three-dimensional data of the object that is captured at the collision point of the at least one part of the visually presented user with the visually presented object is reproduced in the tactile subsystem, wherein the haptic element has a surface with a structure that is designed to reproduce the three-dimensional structure of the object at the collision point based on the three-dimensional data of the object that is captured, at least in the area of the collision point.

10. Method according to claim 9, characterized in that
hand movement of the user is captured in real time when the three-dimensional data of the user is captured,
a visual real-time presentation of the hand movement of the user is generated based on the captured hand movement of the user,
the visual real-time presentation of the hand movement is represented in the visual subsystem, wherein the interaction of the visually presented real-time representation of the hand movement of the user is represented with the visually presented object in the visual subsystem, so the real-time representation of the hand movement of the user interacts with the visually presented object, wherein the collision point is calculated when there is a collision of the visually presented real-time representation of the hand movement of the user with the visually presented object in the visual subsystem and
at least the three-dimensional data of the object captured at the collision point is reproduced in the tactile subsystem.

11. Method according to claim 9 further comprising
capture of eye movements of the user,
processing the captured eye-movement data and determination of an active field of view of the user,
implementation of the captured eye-movement data and of the active field of view in the visual subsystem, wherein the captured eye-movement data of the user provides a local adjustment of the visual presentation of the objects and of the visual presentation of the hand movements in the area of the active field of view.

12. Use of a system according to claim 1 in medical imaging diagnostics, in the construction of vehicles and mechanical engineering, in material testing and in the areas of leisure, sports, entertainment and shopping.
